(19) United States
(12) Patent Application Publication
(10) Pub. No.: US 2019/0199019 A1
(43) Pub. Date: Jun. 27, 2019

(54) INTERDIGITATED POWER CONNECTOR

(71) Applicant: International Business Machines Corporation, Armonk, NY (US)

(72) Inventors: Paul W. Coteus, Yorktown, NY (US); Andrew Ferencz, Southborough, MA (US); Shawn A. Hall, Pleasantville, NY (US); Todd E. Takken, Brewster, NY (US)

(21) Appl. No.: 15/853,806

(22) Filed: Dec. 24, 2017

(51) Int. Cl. H01R 12/51; H01R 12/70; H01R 12/52; H01R 4/36

(52) U.S. Cl. CPC H01R 12/515; H01R 4/363; H01R 12/523; H01R 12/7088

(57) ABSTRACT

An electrical connector carries large amounts of electrical current between two circuit boards with low resistance and low self-inductance by means of an interdigitated anode and cathode, thereby providing low dynamic voltage loss. The connector also may include, near where power will be consumed, an interposer board with on-board capacitance to provide even lower dynamic voltage loss. The connector has application to delivering low-voltage, high-current power from a power supply on a first board to electronics on a second board: the low resistance provides low voltage drop for a load current that is constant, while the low inductance and the capacitors provide low voltage fluctuation for a load current that changes. These issues are of great importance, for example, in designing high-performance computers.

### FEDERALLY SPONSORED RESEARCH AND DEVELOPMENT

This invention was made with government support under contract B601996 awarded by the Department of Energy. The government has certain rights in the invention.

### BACKGROUND

In the field of electronics, and in particular in the field of high-performance computers, it is highly desirable to reduce the consumption of electrical power as much as possible. Toward this end, new generations of power supplies are designed to minimize loss, and new generations of processors and memory systems are designed to dissipate less power despite higher computational performance. An effective technique in reducing the power consumption P of electronics is to lower the operating voltage V. Yet, because P=VI, where I is current in amperes flowing through the electronics, reduced voltage V implies higher current I, despite reduction in power P.

Thus, for such low-voltage, high-current electronics, a power connector must be capable of handling large current I. The current I must be delivered substantially at potential V from a supply terminal of a power supply to the electronics, and must be returned substantially at zero potential from the electronics to a return terminal of the power supply. A power-connector terminal connecting to the supply terminal of the power supply is called an “anode”, whereas a power-connector terminal connecting to the return terminal of the power supply call a “cathode”. The supply-terminal potential and the return-terminal potential may be referred to as “power” and “ground” respectively. Let ΔVₛ be the voltage drop that occurs as current I travels from the supply terminal to the electronics; let ΔVᵣ be the voltage drop that occurs as current I travels from the electronics to the return terminal; and let ΔVₒ be other overhead voltage drop that occurs, such as in conductors other than the connector. Let Rₛ, Rᵣ, and Rₒ be the resistances corresponding to the voltage drops ΔVₛ, ΔVᵣ and ΔVₒ respectively; that is,

ΔVₛ=IRₛ; ΔVᵣ=IRᵣ; ΔVₒ=IRₒ. (1)

A total overhead voltage drop ΔV_{TOTAL} may therefore be defined as

ΔV_{TOTAL}≡ΔVₛ+ΔVᵣ+ΔVₒ=I(Rₛ+Rᵣ+Rₒ) (2)

For electronics such as a processor and memory, another common method of power reduction is to reduce, as processor workload changes, the processor's operating voltage V and/or a clock frequency f at which the processor operates. A popular technique is called dynamic voltage-frequency scaling (DVFS), in which both V and f are dropped proportionally when workload is reduced, and raised again when workload is increased. Consequently, the current I from the power supply to the processor and memory varies strongly in time. This leads to voltage fluctuation at the processor and memory, because an inductive voltage drop ΔV_{L} occurs across the power connector according to Faraday's Law,

$$Δ {V}_{L} = L \frac{dI}{dt} , \qquad ( 3 )$$

where L is a self-inductance of the power connector and

$$\frac{dI}{dt}$$

is a change in current per unit time through the connector. Because a technique such as DVFS can produce large

$$\frac{dI}{dt} ,$$

the self-inductance L of the power connector must be small, according to equation (3), to avoid large voltage fluctuations ΔV_{L}.

Some prior-art, high-current power connectors achieve (1) and (2), but fail to achieve (3). For example, a power connector comprising an array of pins, with each pin being either power or ground, has relatively high self-inductance. Other prior-art connectors, such as coaxial or stripline connectors, achieve (3) but fail to achieve (1): they are typically restricted to just a few amperes of current per contact.

Thus it is highly desirable to find a connector structure that achieves (1), (2), and (3) simultaneously, and does so in a compact package for the purpose of reducing Rₒ. For example, a useful target set of specifications is

I=100 A; R_{CONN}≡Rₛ+Rᵣ≤50μΩ; L_{CONN}≤500 pH, (4)

where the inductance specification in (4) arises from a desire to achieve a dynamic voltage drop of at most ΔV_{L}=50 [mV] with

$$\frac{dI}{dt} = 100 \frac{A}{µs} .$$

### SUMMARY

Principles of the invention provide techniques for an interdigitated power connector that achieves relatively low resistance and inductance. In one aspect, an exemplary apparatus includes an electrical connector for conducting current substantially parallel to a z direction of a Cartesian coordinate system having an x axis, a y axis, and a z axis, all mutually orthogonal, thereby defining an xy plane spanned by the x and y axes, an xz plane spanned by the x and z axes, and a yz plane spanned by the y and z axes. In this context, the electrical connector includes an anode formed into a first shape of uniform cross-section along the z direction, the first shape having a plurality of anode fingers that alternate with a plurality of anode gaps; and a cathode formed into a second shape of uniform cross-section along the z direction, the second shape having a plurality of cathode fingers that alternate with a plurality of cathode gaps. The first and second shapes provide a conformity of one to the other, with the anode fingers being interdigitated with the cathode fingers and separated from the cathode fingers by an insulative anode-to-cathode gap.

In another aspect, an exemplary apparatus includes an electrical connector for conducting current substantially parallel to a z direction of a Cartesian coordinate system having an x axis, a y axis, and a z axis, all mutually orthogonal, thereby defining an xy plane spanned by the x and y axes, an xz plane spanned by the x and z axes, and a yz plane spanned by the y and z axes. In this context, the electrical connector includes an anode formed into a first shape of uniform cross-section along the z direction, the first shape having a plurality of anode fingers that alternate with a plurality of anode gaps; a cathode formed into a second shape of uniform cross-section along the z direction, the second shape having a plurality of cathode fingers that alternate with a plurality of cathode gaps; and an interposer assembly, which is attached on its positive-z-facing surface to the negative-z-facing surfaces of the anode and cathode, the interposer assembly having an interposer printed-circuit board and a plurality of capacitors affixed to the interposer printed-circuit board to provide a capacitance. The first and second shapes provide a conformity of one to the other, with the anode fingers being interdigitated with the cathode fingers and separated from the cathode fingers by an insulative anode-to-cathode gap. The anode and the cathode are indented with slots at their negative-z-facing surfaces, and the capacitors of the interposer assembly fit into the slots of the anode and the cathode.

In another aspect, an exemplary method for reducing dynamic voltage drop in a board-to-board assembly includes connecting a source printed-circuit board to a destination printed-circuit board via an interdigitated electrical connector, which includes an anode formed into a first shape of uniform cross-section along a z direction, the first shape having a plurality of anode fingers that alternate a plurality of anode gaps, and a cathode formed into a second shape of uniform cross-section along the z direction, the second shape having a plurality of cathode fingers that alternate with a plurality of cathode gaps. The first and second shapes provide a conformity of one to the other, with the anode fingers being interdigitated with the cathode fingers and separated from the cathode fingers by an insulative anode-to-cathode gap. The exemplary method further includes providing a time-varying current from the source to the destination via the interdigitated electrical connector.

The invention provides substantial technical benefits, including reduced resistance and inductance compared to prior art connectors. Moreover, the invention provides a relatively compact solution for efficiently conducting relatively high and rapidly varying currents from source to destination. Furthermore, one or more embodiments advantageously provide

(1) high current-carrying capacity,

(2) low connector resistance R_{CONN}=Rₛ+Rᵣ, and

(3) low self-inductance L_{CONN}.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 illustrates an exploded view of a power connector according to a first embodiment;

FIG. 2 illustrates an assembled view of the power connector of FIG. 1;

FIG. 3 illustrates an assembled view of the power connector of FIG. 1 with anode and cathode transparent;

FIG. 4 illustrates an exploded view of a board-to-board assembly including the power connector of FIG. 1;

FIG. 5 illustrates an upside-down exploded view of the board-to-board assembly of FIG. 4;

FIG. 6 illustrates parameters for computing self-inductance of two parallel plates;

FIG. 7 illustrates parameters for computing self-inductance of the power connector of FIG. 1;

FIG. 8 illustrates an exploded view of a board-to-board assembly according to a second embodiment;

FIG. 9 illustrates an exploded view of a board-to-board assembly according to a third embodiment;

FIG. 10 illustrates an assembled view of a board-to-board assembly according to a fourth embodiment;

FIG. 11 illustrates an exploded view of the board-to-board assembly of FIG. 10;

FIG. 12 illustrates an exploded view of an interposer assembly of the board-to-board assembly of FIG. 10;

FIG. 13 illustrates a bottom perspective view of a connector assembly of the board-to-board assembly of FIG. 10;

FIG. 14 illustrates an electrical schematic diagram of a model of the board-to-board assembly of FIG. 10;

FIG. 15a illustrates frequency response of the model of FIG. 14 for capacitance C=1 μF;

FIG. 15b illustrates frequency response of the model of FIG. 14 for capacitance C=2 μF;

FIG. 15c illustrates frequency response of the model of FIG. 14 for capacitance C=5 μF;

FIG. 15d illustrates frequency response of the model of FIG. 14 for capacitance C=10 μF;

FIG. 15e illustrates frequency response of the model of FIG. 14 for capacitance C=20 μF; and

FIG. 15f illustrates frequency response of the model of FIG. 14 for capacitance C=50 μF.

### DETAILED DESCRIPTION

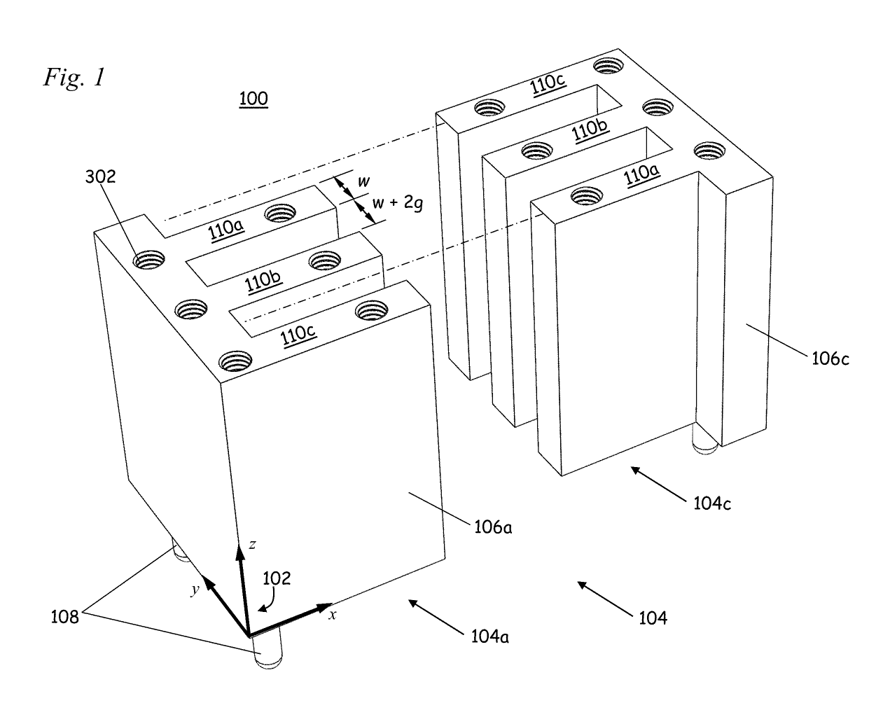

### Description and Operation of a First Embodiment (FIGS. 1-7)

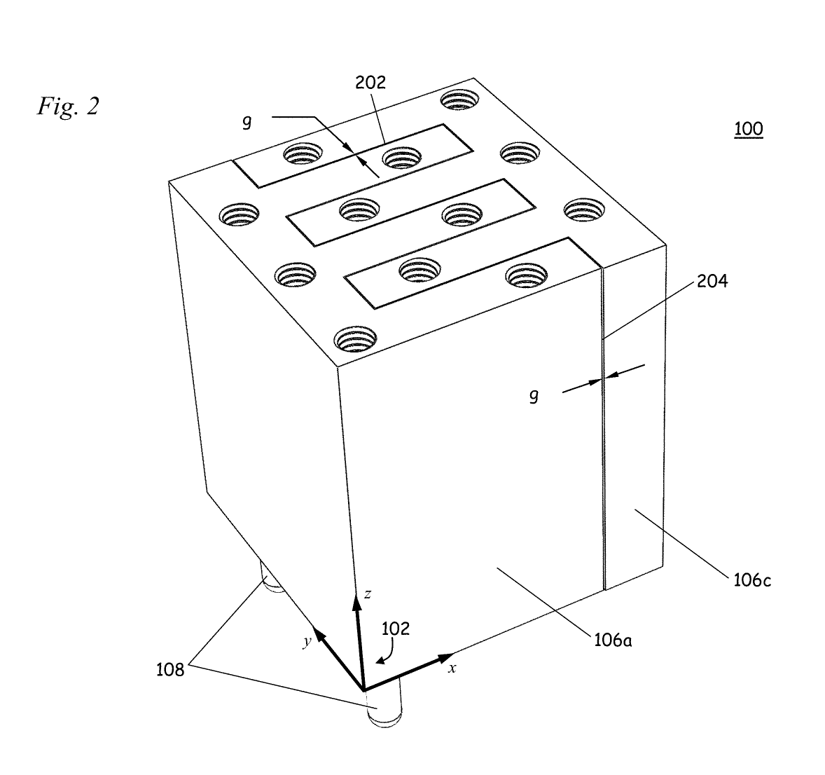

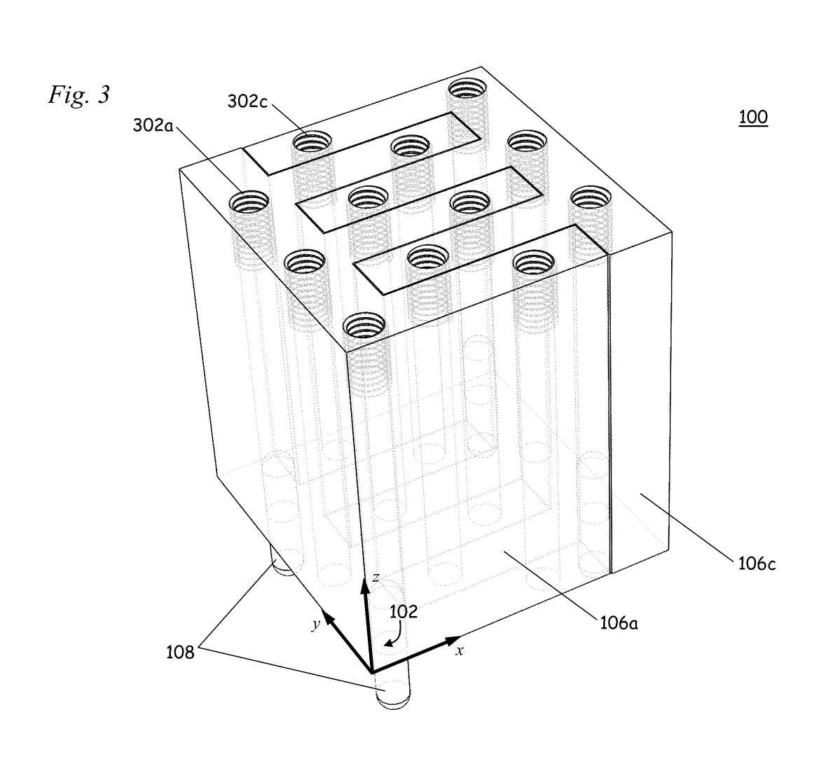

FIGS. 1 through 3 illustrate a first embodiment of an interdigitated power connector 100 that achieves low resistance and low self-inductance in a compact space. Connector 100 will be described in the context of a Cartesian coordinate system 102 that includes an x axis, a y axis, and a z axis, all mutually orthogonal, thereby defining an xy plane spanned by the x axis and the y axis, an xz plane spanned by the x axis and the z axis, and a yz plane spanned by they axis and the z axis. The connector 100 includes two identical electrodes assemblies, including an anode assembly 104a and a cathode assembly 104c. These two assemblies are shown exploded on FIG. 1. They are shown assembled on FIG. 2 and FIG. 3; FIG. 3 shows connector 100 as “transparent”, so that lines normally hidden are revealed. Referring to anode assembly 104a on FIG. 1, each of the identical electrode assemblies includes an electrode 106a or 106c and two locating pins 108. For anode assembly 104a, the electrode is called an anode 106a; for the identical cathode assembly 104c, the electrode is called a cathode 106c. Each electrode 106a or 106c includes a plurality of fingers 110, instances of which are denoted 110a, 110b and 110c. The width of each finger in they direction is denoted w. Fingers 110 are separated by interdigit spaces; the width of each interdigit space in they direction is denoted w+2g. The anode 106a and the cathode 106b can be manufactured of any suitable conductive material, including for example copper.

Consequently, referring to FIG. 2, when the two electrodes are assembled, a side gap 202 of dimension g is provided in the y direction between each finger of the anode and the adjacent finger of the cathode. An end gap 204 of dimension g is also provided in the x direction where a fingertip on one of the electrodes approaches a finger-base on the other electrode. Consequently, because of gaps 202 and 204, the anode and the cathode are electrically insulated from each other. The side and end gaps may be filled with an insulator such as vacuum, air, or any other insulating material that, for example, may be applied as a coating to a plurality of interdigit surfaces, the interdigit surfaces being formed by the positive-y-facing and negative-y-facing surfaces of each finger, excluding the end surfaces of assembly 100, as well as the positive-x-facing and negative-x-facing surfaces of each finger.

Referring to FIG. 3, anode 106a is formed with a plurality of holes 302a, and cathode 106c is formed with a plurality of holes 302c. As illustrated in FIG. 3, holes 302a and 302c may be through holes, as may be economically formed if the electrode is extruded, for example. Alternatively, holes 302a and 302c may be blind on each end. In either case, on the negative-z-facing surface of the electrode, locating pins 108 are press fit into two of the holes in each electrode. Near the positive-z-facing surface of the electrode, each of the holes 302a and 302c has a threaded portion.

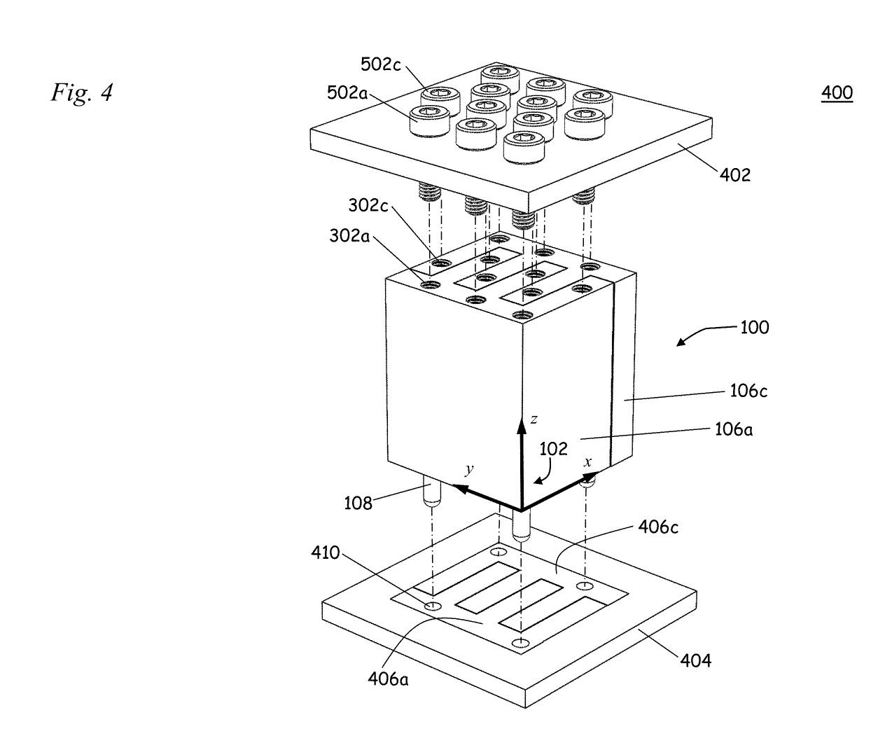

FIG. 4 illustrates an exploded view of a board-to-board assembly 400 depicting typical deployment of the connector assembly 100. Connector 100 transmits a power domain, characterized by its anode-voltage V₁, from a first printed circuit board (PCB) 402, where voltage V₁ is generated, to a second PCB 404, where voltage V₁ is used to power various electronic devices.

Connector 100 is located with respect to PCB 404 by locating pins 108, which engage holes 410. Connector 100 is soldered to PCB 404 using copper pads 406 printed thereon by means well known in the art of PCB manufacturing; specifically, the negative-z-facing surface of anode 106a is soldered to a copper pad 406a, and the negative-z-facing surface of cathode 106c is soldered to a copper pad 406c. As will be further discussed below, attachment means other than the copper pads and the locating pins may be used (e.g., threaded fasteners).

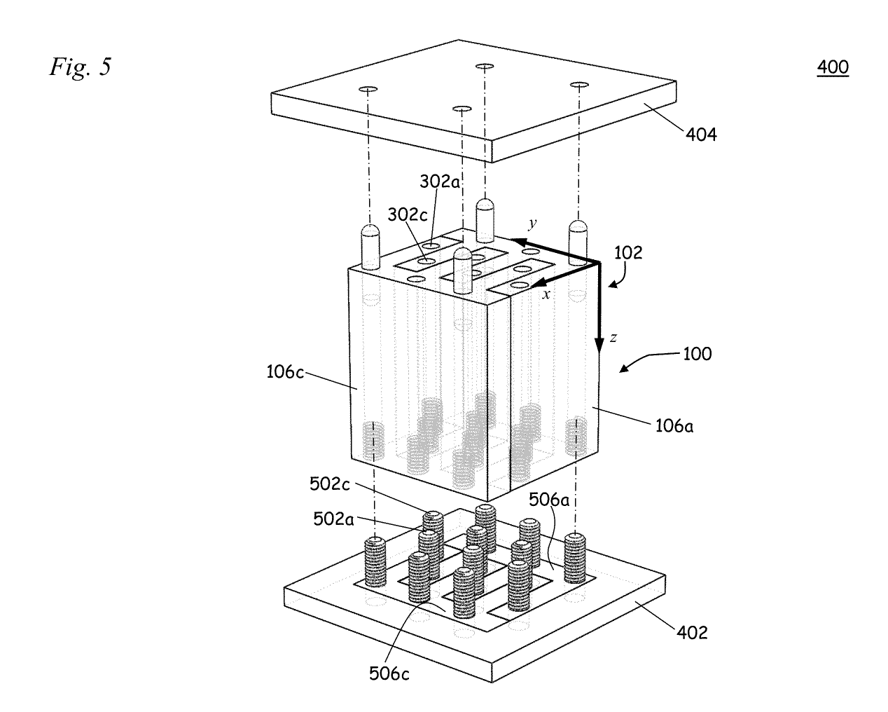

FIG. 5 is an upside-down exploded diagram of assembly 400 that illustrates an attachment of connector 100 to PCB 402. Connector 100 is shown as transparent. The attachment of connector 100 to PCB 402 is achieved with a plurality of anode fasteners 502a and a plurality of cathode fasteners 502c. The fasteners pass through clearance holes in PCB 402. These fasteners engage the threaded portions of holes 302a and 302c respectively. As shown, PCB 402 includes a copper pad 506a, printed on the negative-z-facing surface thereof, whose multi-finger shape matches that of anode 106a. Likewise, PCB 402 includes a copper pad 506c whose multi-finger shape matches that of cathode 106c. A threaded portion of fasteners 502a pass through clearance holes in PCB 402 that penetrate pad 506a. Likewise, a threaded portion of fasteners 502c pass through clearance holes in PCB 402 that penetrate pad 506c. Tightening fasteners 502a achieves a low-resistance anode connection for connector 100 by pulling the positive-z-facing surface of anode 106a with high normal force against pad 506a. Likewise, tightening fasteners 502c achieves a low-resistance cathode connection for connector 100 by pulling the positive-z-facing surface of cathode 106c with high normal force against pad 506c. As discussed above, attachment means other than threaded fasteners may be used (e.g., solder).

The low-resistance connections referred to above are best achieved when the positive-z-facing surfaces of the electrodes 106a and 106c are coplanar. Coplanarity is best achieved by temporarily affixing, prior to soldering the negative-z-facing surfaces of the electrodes to PCB 404, a substantially rigid plate to the positive-z-facing surfaces of the electrodes, using fasteners such as 502a and 502c. This insures that the soldering process will not spoil the coplanarity of the positive-z-facing surfaces.

Operation of the first embodiment includes electrical performance of connector 100; in particular, the resistance and inductance thereof.

Resistance R_{CONN} for connector 100 per se is

$${R}_{CONN} = 2 \frac{{ρ𝓁}_{1}}{{A}_{1}} , \qquad ( 5 )$$

where ρ is the resistivity of the electrode material, [symbol] ₁ is a length of the electrode in the z direction, and A₁ is a cross-sectional area of the electrode parallel to the xy plane. Equation (5) ignores contact resistance at the fasteners, which is estimated separately later. The factor of two in equation (5) accounts for the presence of two electrodes, 106a and 106c, that form the connector 100. For a prototype of connector 100 in which the electrodes are copper, l₁=29 [mm] and A₁=282 [mm²], whence

$${R}_{CONN} = 2 \frac{( 1.6 \times {10}^{- 5} [ Ω \text{-} mm ] ) ( 29 [ mm ] )}{282 [ {mm}^{2} ]} = 3.3 [ µΩ ] . \qquad ( 6 )$$

It is useful also to estimate a contact resistance R_{CONTACT} at each of the threaded fasteners 502. Using a commonly accepted formula for contact resistance, as reported by Hirpa L. Gelgele in “Study of Contact Area and Resistance in Contact Design of Tubing Connections”, 13^{th} International Research/Expert Conference, Trends in the Development of Machinery and Associated Technology, T M T 2009, Hammamet, Tunisia, October 2009, the contact resistance R_{CONTACT} in Ohms for metallic surfaces that are free of insulating contaminants may be calculated from

$${R}_{CONTACT} = ρ \sqrt{\frac{π {H}_{V}}{4 F}} , \qquad ( 7 )$$

where ρ is resistivity of the metal in Ohm-meters, His Vickers hardness of the softer of the two contacting materials in Pascals, and F is contact force in Newtons. For example, for copper

ρ=1.6×10⁻⁸ [Ω-m]; H_{V}=0.369×10⁹ [Pa] (copper). (8)

In a prototype of the first embodiment, fasteners 502 are M3 machine screws, for which an acceptable axial force is F=1500[N]. Substituting these values into equation (7) yields

$$\begin{matrix}{R}_{CONTACT} = ( 1.6 \times {10}^{- 8} [ Ω \text{-} m ] ) \sqrt{\frac{π ( 0.369 \times {10}^{9} [ \frac{N}{{m}^{2}} ] )}{( 4 ) ( 1500 [ N ] )}} \\ = 7.0 [ µ Ω ] ( one M 3 fastener )\end{matrix} \qquad ( 9 )$$

This is the contact resistance between a prototype of connector 100 and circuit board for a single fastener. Because, in board-to-board assembly 400, anode 106a is fastened to PCB 402 with six fasteners, the anode-to-board contact resistance will be one sixth of that stated in equation (9); that is, about 1.2 μΩ, assuming clean surfaces. The cathode-to-board contact resistance will likewise be about 1.2 μΩ. So the total contact resistance (anode and cathode) is about 2.4μΩ.

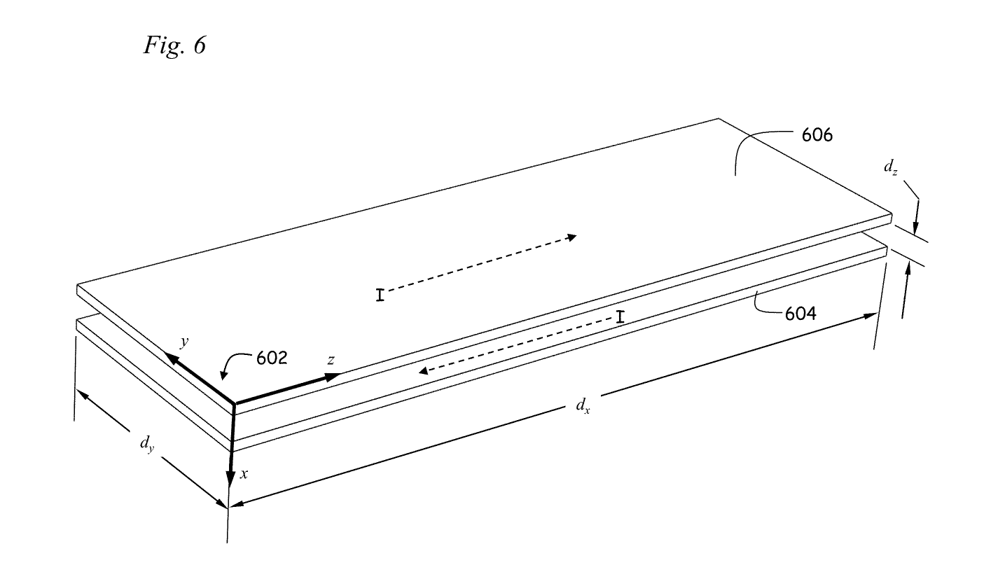

A self-inductance L_{CONN} of connector 100 may be computed using a well-known solution for the self-inductance of parallel plates. Referring to FIG. 6 and a coordinate system 602 thereon having an x direction, a y direction, and a z direction, all mutually orthogonal, thereby defining an xy plane, this solution states that, for a pair of parallel plates including a first parallel plate 604 and a second parallel plate 606 lying parallel to each other and parallel to the xy plane, each plate having dimensions dₓ and d_{y} in the x and y directions respectively, with a gap between them of thickness d_{z}, the gap being filled with an insulating material having a magnetic permeability close to (i.e., within 10% of) the permeability of free space. Exemplary suitable insulating materials include plastics, Teflon, or air, but not ferrites.

$${μ}_{0} = 4 π \times {10}^{- 10} [ \frac{H}{mm} ] , \qquad ( 10 )$$

and with electrical current I flowing toward the +x direction in plate 606 and toward the −x direction in plate 604, the self-inductance of the parallel plates is

$${L}_{PP} = {μ}_{0} \frac{{d}_{x} {d}_{z}}{{d}_{y}} . \qquad ( 11 )$$

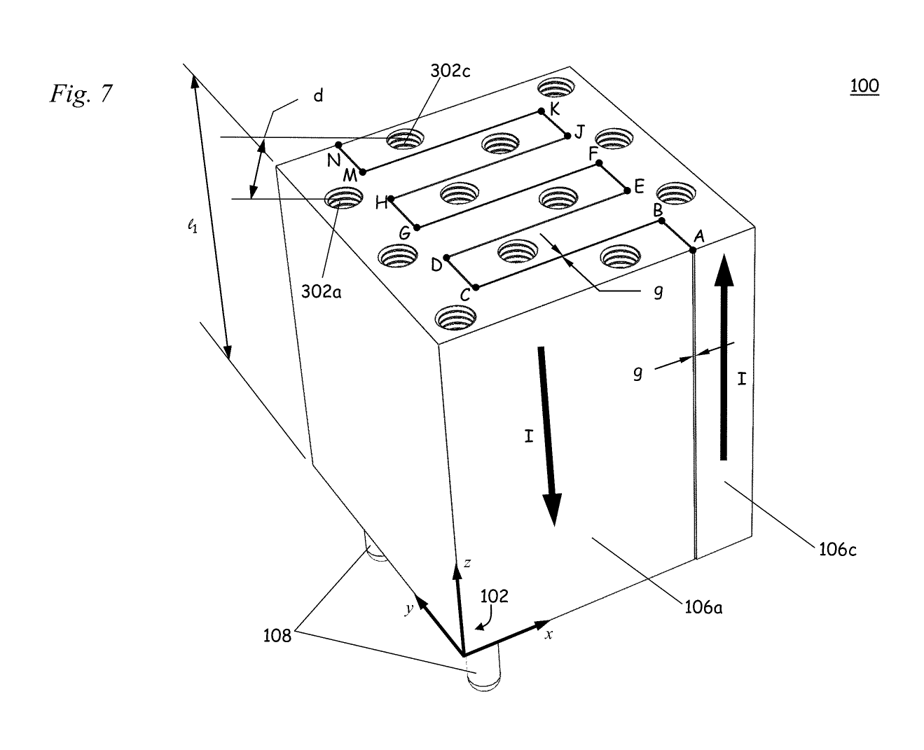

Referring to FIG. 7, let equation (11) be applied to connector 100, in which

dₓ=g; d_{y}=ABCDEFGHJKMN; d_{z}= [symbol] ₁ (12)

where ABCDEFGHJKMN means the length of the serpentine path along the interdigitated surfaces of the anode and cathode fingers. Consequently, the connector self-inductance is

$${L}_{CONN} = {μ}_{0} \frac{{𝓁}_{1 G}}{ABCDEFGHJKMN} . \qquad ( 13 )$$

For example, in the prototype version of connector 100,

[symbol]

₁=29 [mm]; g=0.1 [mm]; ABCDEFGHJKMN=100.8 [mm]. (14)

Consequently, for this prototype, the self-inductance of connector 100 is

$${L}_{CONN} = {μ}_{0} \frac{{𝓁}_{1 G}}{ABCDEFGHJKMN} = ( 4 π \times {10}^{- 10} ) \frac{( 29 ) ( 0.1 )}{( 100.8 )} = 36.2 [ pH ] \qquad ( 15 )$$

When the connector is deployed, as in FIG. 5, another inductance denoted L_{INTO BOARD}, which is in series with L_{CONN}, must be considered. L_{INTO BOARD} involves current flow between connector 100 and PCB 402. Assume that such current can flow only in areas where anode 106a and cathode 106c are intimately in contact with PCB 402; this is not really true for high-frequency current, but assume pessimistically that it is true. Intimate contact typically occurs in the annular areas under the head of each fastener 502, assumed to have a head diameter 2a, because that is where large pressure is applied. Thus, referring to FIG. 7, there is an inductance associated with current I flowing out of PCB 402 into anode 106a in the vicinity of a hole 302a and flowing back into PCB 402 from cathode 106c in the vicinity of hole 302c. If the current flowing in these areas must penetrate into the board by a distance [symbol] ₂ before reaching a power plane, then the inductance created by the hole-pair geometry (302a and 302c) is similar to that of two parallel wires, each of diameter 2a and length [symbol] ₂, separated by a hole-to-hole distance d. The well-known inductance formula for this case is

$${L}_{HOLE PAIR} = \frac{{μ}_{0} {𝓁}_{2}}{π} ( ln \frac{d}{a} + c ) , \qquad ( 16 )$$

where c=0 for high-frequency current, which shall be assumed. For the prototype connector 100 and its deployment with circuit board 402,

2a=5.5 [mm]; d=8.3 [mm]; [symbol] ₂=1 [mm], (17)

whence, for the prototype

$$\begin{matrix}{L}_{HOLE PAIR} = \frac{{μ}_{0} {𝓁}_{2}}{π} ( ln \frac{d}{a} + c ) \\ = \frac{( 4 π \times {10}^{- 10} [ H \text{/} mm ] ) ( 1 [ mm ] )}{π} ln ( \frac{8.3 [ mm ]}{2.75 [ mm ]} ) \\ = 442 [ pH ]\end{matrix} \qquad ( 18 )$$

Equation (18) would represent a fair estimate of L_{INTO BOARD} if there were only one anode hole 302a and one cathode hole 302c. In fact, however, the plurality of anode holes 302a is interspersed with the plurality of cathode holes 302c. Consequently, L_{INTO BOARD} is a fraction of L_{HOLE PAIR}. In general, calculation of L_{INTO BOARD} is complex, because each anode hole has several neighboring cathode holes. However, pessimistically pairing each anode hole with only one cathode hole, an upper bound on L_{INTO BOARD} may be estimated by regarding the hole pairs as equal inductances in parallel, and thus simply dividing L_{HOLE PAIR} by the number N of hole pairs. That is,

$${L}_{INTO BOARD} \leq \frac{{L}_{HOLE PAIR}}{N} . \qquad ( 19 )$$

For example, for the prototype, N=6, so, substituting (18) into (19),

$${L}_{INTO BOARD} \leq \frac{442 [ pH ]}{6} = 73.7 [ pH ] . \qquad ( 20 )$$

Consequently, total inductance including L_{INTO BOARD} is

L_{TOTAL}=L_{CONN}+L_{INTO BOARD}, (21)

and the nomenclature of the target specification given in (4) should be modified to

L_{TOTAL}<500 [pH]. (22)

For the prototype, substituting (15) and (20) into (21) yields

L_{TOTAL}≤36.2 [pH]+73.7 [pH]≈110 [pH], (23)

which satisfies the target specification (22).

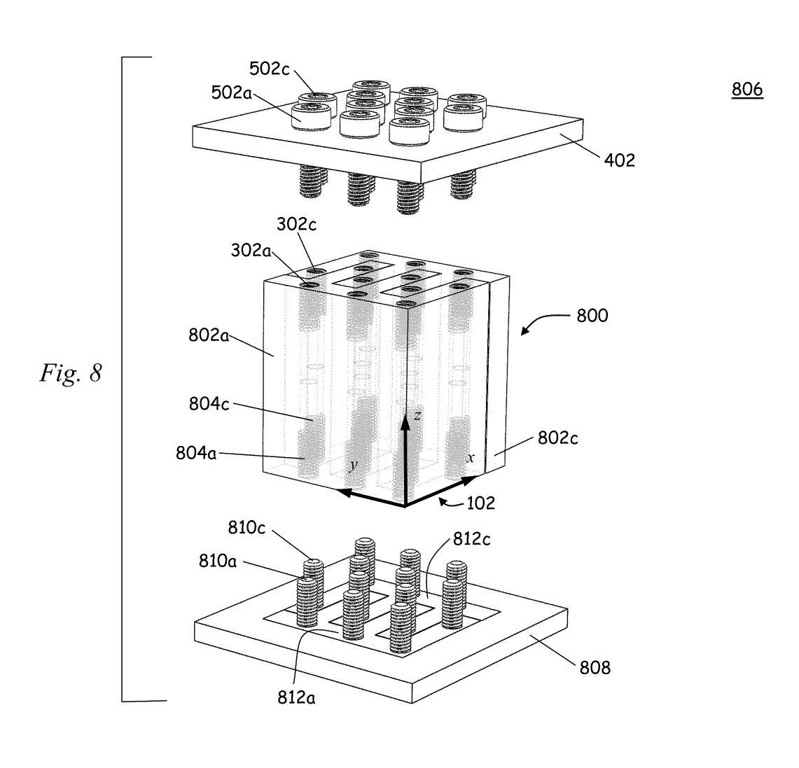

### Description and Operation of a Second Embodiment (FIG. 8)

FIG. 8 illustrates, according to a second embodiment, a connector 800 that is similar to connector 100. Connector 800 includes two electrodes, an anode 802a and a cathode 802c, which are assembled in a manner identical to that described in connection with FIG. 2 in connection with electrodes 106a and 106c. The only difference between anode 802a of connector 800 and anode 106a of connector 100 is that, in anode 802a, the lower portion of each anode hole 302a has a threaded portion 804a. Likewise, the only difference between cathode 802c of connector 800 and cathode 106c of connector 100 is that, in cathode 802c, the lower portion of each cathode hole 302c has a threaded portion 804c. Consequently, locating pins 108 are not used in connector 800.

FIG. 8 further illustrates, in an exploded diagram analogous to FIG. 4, connector 800 deployed in a board-to-board assembly 806, which includes connector 800, PCB 402, anode fasteners 502a and cathode fasteners 502c for PCB 402, a PCB 808, a plurality of anode fasteners 810a for PCB 808, and a plurality of cathode fasteners 810c for PCB 808. The PCB 402 is fastened to the positive-z-facing surface of connector 800 as described for the first embodiment. In an exactly analogous fashion, PCB 808 is fastened to the negative-z-facing surface of connector 800. That is, a plurality of fasteners 810a engage threaded portions 804a to provide, when tightened, a low-resistance anode connection to a copper pad 812a printed upon board 808, pad 812a having a multi-finger shape that substantially matches the shape of anode 802a. Likewise, a plurality of fasteners 810c engage threaded portions 804c to provide, when tightened, a low-resistance cathode connection to a copper pad 812c printed upon board 808, pad 812c having a multi-finger shape that substantially matches the shape of cathode 802c.

The second embodiment is useful for applications in which a separable connection is desired between the connector 800 and both of the sandwiching PCBs.

Electrical operation of the second embodiment is similar to the first embodiment, except that there is additional contact resistance and inductance associated with the additional threaded connection of PCB 808 to connector 800. For example in the prototype, the additional threaded connection will cause about 2.4 μΩ of additional resistance, as calculated for the first embodiment following equation (9), and will cause about 73.7 pH of additional inductance, raising the upper bound on L_{TOTAL} to

L_{TOTAL}≤L_{CONN}+2L_{INTO BOARD}=183.6 [pH] (24)

according to equations (15) and (20).

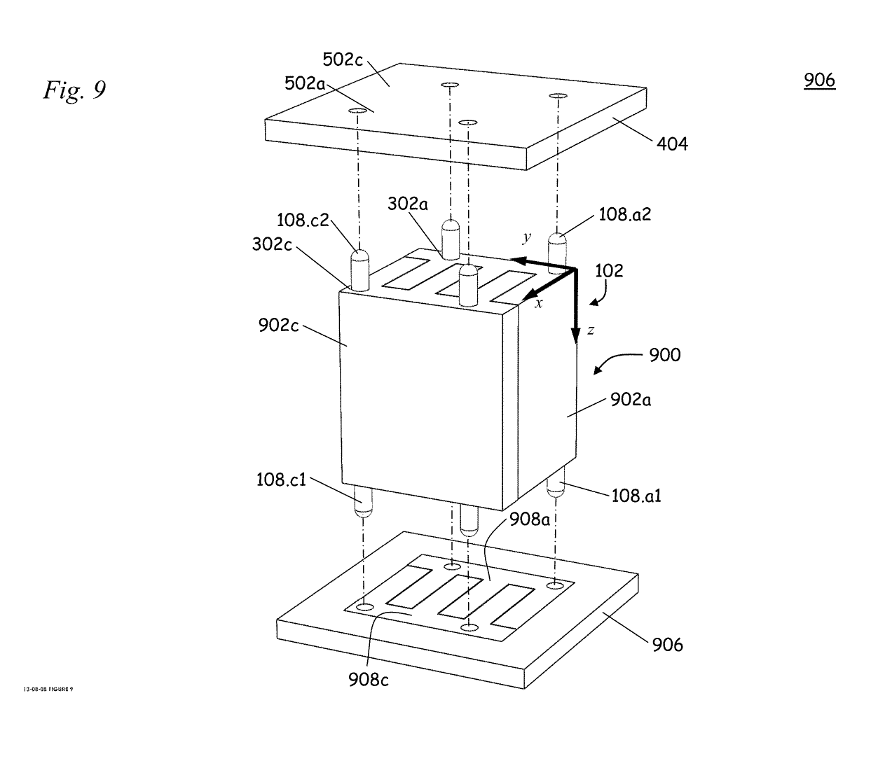

### Description and Operation of a Third Embodiment (FIG. 9)

FIG. 9 illustrates, according to a third embodiment, a connector 900 that is similar to connector 100. Connector 900 includes two electrodes, an anode 902a and a cathode 902c, which are assembled in a manner identical to that described in connection with FIG. 2 in connection with electrodes 106a and 106c. The difference between anode 902a of connector 800 and anode 106a of connector 100 is that anode 902a has only two holes 302a, both of which are unthreaded on both ends, and each of which is populated with an instance of locating pin 108 denoted 108.a1 that protrudes from the positive-z-facing surface of anode 902a, as well as an instance of locating pin 108 denoted 108.a2 that protrudes from the negative-z-facing surface of anode 902a. Likewise, the difference between cathode 902c of connector 800 and cathode 106c of connector 100 is that cathode 902c has only two holes 302c, both of which are unthreaded on both ends, and each of which is populated with an instance of locating pin 108 denoted 108.c1 that protrudes from the positive-z-facing surface of cathode 902c, as well as an instance of locating pin 108 denoted 108.c2 that protrudes from the negative-z-facing surface of cathode 902c.

FIG. 9 further illustrates, in an upside-down exploded diagram analogous to FIG. 5, connector 900 deployed in a board-to-board assembly 906 that includes connector 900, PCB 404, and a PCB 906. Referring to the upside-down coordinate system on FIG. 9, PCB 404 is attached to the negative-z-facing surface of connector 900 with solder, as described in the first embodiment, to achieve low-resistance connections of anode 902a and cathode 902c to copper pads 506a and 506c respectively, these pads being not visible on FIG. 9, but visible on FIG. 5. Likewise, PCB 906 is attached to the positive-z-facing surface of connector 900 with solder, to achieve low-resistance connections of anode 902a and cathode 902c to copper pads 908a and 908c respectively, these pads being printed on the negative-z-facing surface of PCB 906.

The third embodiment is useful for applications in which a permanent, soldered connection is desired between the connector 800 and both of the sandwiching PCBs. Electrical operation of the third embodiment is similar to the first embodiment, except that the contact resistance and inductance associated with the threaded connection to PCB 402 in the first embodiment is eliminated by the soldered connection of PCB 906 in the second embodiment. For example in the prototype, removing the threaded connection reduces resistance by cause about 2.4 μΩ and reduces inductance by about 73.7 pH, thereby lowering the inductance upper bound to

L_{TOTAL}≤L_{CONN}=36.2 [pH]. (25)

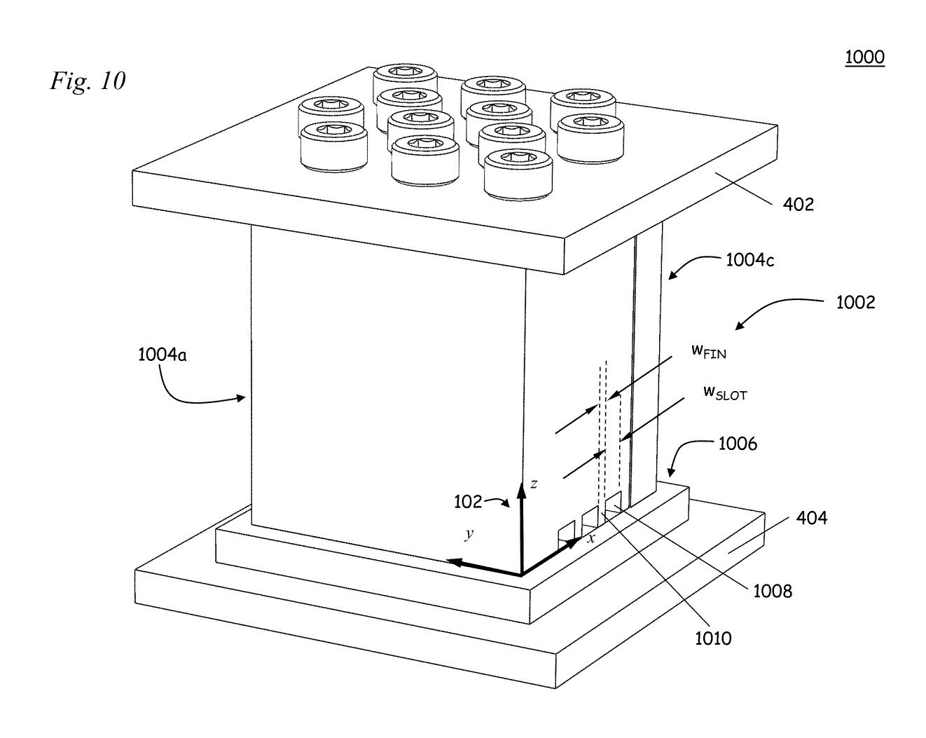

### Description and Operation of a Fourth Embodiment (FIGS. 10-14 and 15a-15f)

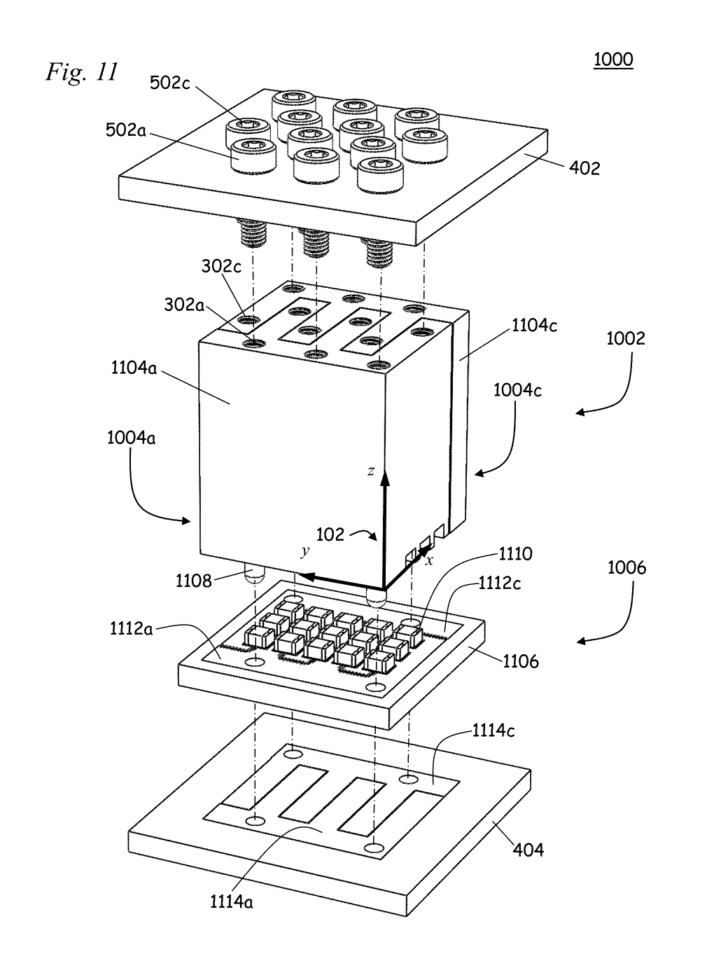

FIG. 10 and FIG. 11 illustrate, according to a fourth embodiment, a power connector 1002, shown in the context of a board-to-board assembly 1000 that includes, in addition to power connector 1002, an interposer assembly 1006, the first PCB 402 on which voltage V₁ is generated, and the second PCB 404 where voltage V₁ is used to power various electronic devices. Power connector 1002 includes an anode assembly 1004a and an identical cathode assembly 1004c. Board-to-board assembly 1000 is shown assembled on FIG. 10 and exploded on FIG. 11.

Referring to FIG. 11, anode assembly 1004a includes an anode 1104a and two locating pins 1108 that protrude from the negative-z-facing surface thereof to locate it to the interposer assembly 1006; likewise, cathode assembly 1004c includes a cathode 1104c and two additional locating pins 1108 (not visible on FIG. 11). Anode 1104a has, on the positive-z-facing surface thereof, a plurality of threaded holes 302a for the attachment of PCB 402 using threaded fasteners 502a as previously described for the first embodiment. Likewise, cathode 1104c has, on the positive-z-facing surface thereof, a plurality of threaded holes 302c for the attachment of PCB 402 using fasteners 502c. Defining N_{S} is an integer greater than zero and referring to FIG. 10, anode 1104a and cathode 1104c each also have, cut into the negative-z-facing surface thereof, N_{S} slots 1008, each of width w_{SLOT}. Slots 1008 create N_{S} fins 1010, each of width w_{FIN}.

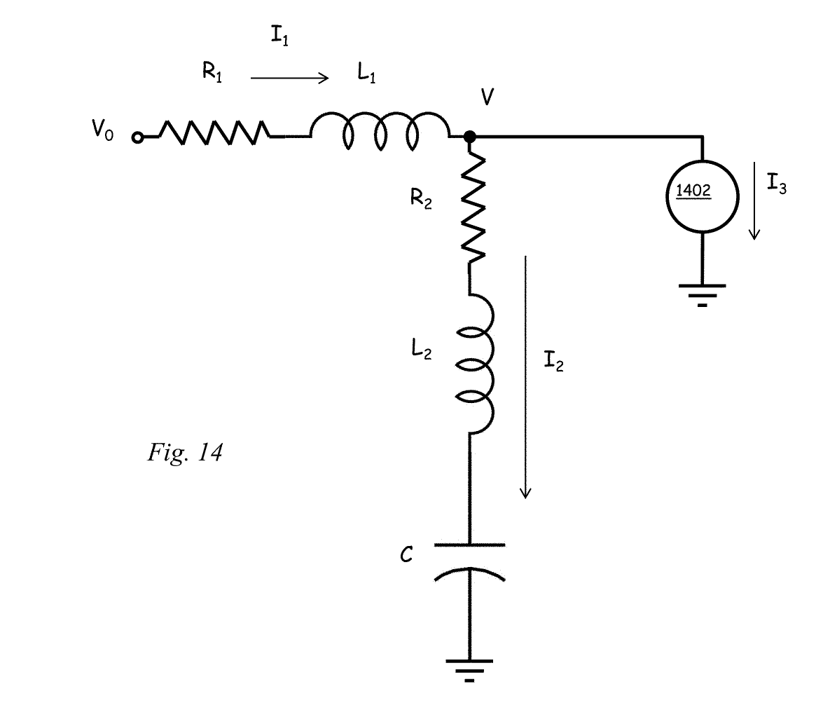

Interposer assembly 1006 includes an interposer circuit board 1106, also known as “interposer 1106”, and a plurality of capacitors 1110 soldered thereto. Capacitors 1110 are accommodated by slots 1008. Anode 1104a is affixed with solder to a copper pad 1112a that is printed upon the positive-z-facing surface of interposer 1106. Likewise, cathode 1104c is affixed with solder to a copper pad 1112c. Interposer 1106 is affixed to PCB 404 using copper pads printed upon the negative-z-facing surface thereof, which are soldered to similarly shaped pads 1114a and 1114c printed upon the positive-z-facing surface of PCB 404. An electronic load 1404, not shown in FIG. 11, but shown schematically in FIG. 14, is connected to PCB 404.

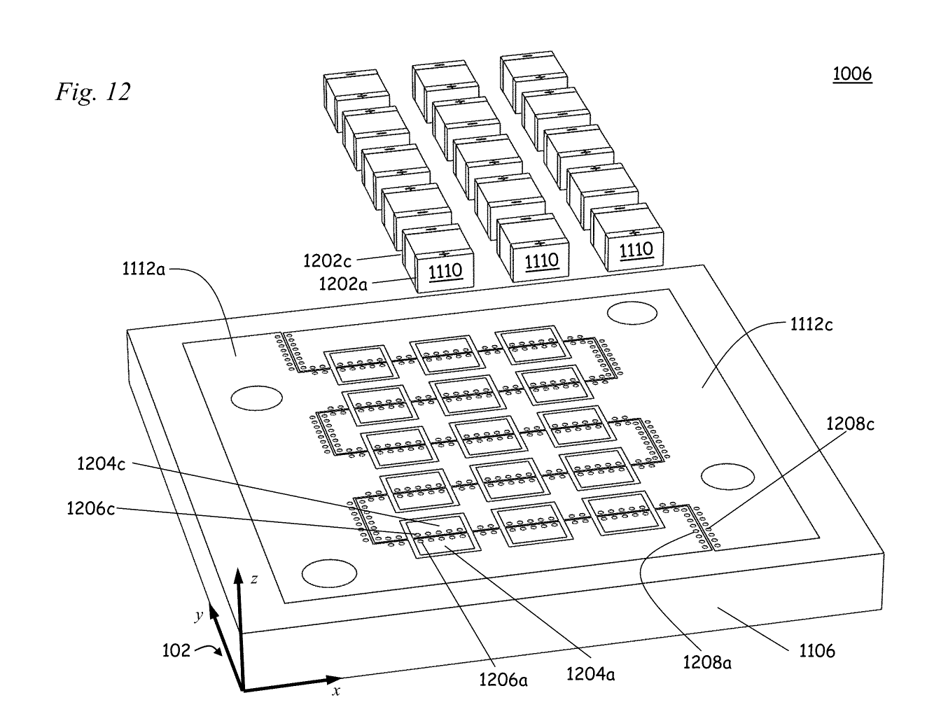

FIG. 12 illustrates an exploded view of interposer assembly 1006. Each capacitor 1110 includes a first terminal 1202a labeled “+” on FIG. 12, and a second terminal 1202c labeled “-” on FIG. 12. For each capacitor, first terminal 1202a is soldered to a first copper capacitor pad 1204a printed upon the positive-z-facing surface of interposer 1106. Likewise, for each capacitor, second terminal 1202c is soldered to a second copper capacitor pad 1204c printed upon the positive-z-facing surface of interposer 1106. Capacitor pads 1204a are electrically connected to a bottom anode pad (not shown) located on the negative-z-facing surface of interposer 1106 that overlays and is soldered to copper pad 1114a (shown on FIG. 11) on the positive-z-facing surface of PCB 404. Likewise, capacitor pads 1204c are electrically connected, within the internal structure of the interposer, to a bottom cathode pad (not shown) located on the negative-z-facing surface of interposer 1106 that overlays and is soldered to copper pad 1114c (shown on FIG. 11) on the positive-z-facing surface of PCB 404. Thus, because capacitor pads 1204a and 1204c are electrically connected to pads 1114a and 1114c respectively, all capacitors 1110 are connected electrically in parallel across anode and cathode.

Still referring to FIG. 12, a plurality of anode capacitor vias 1206a connects each capacitor pad 1204a to the bottom anode pad (not shown) on the negative-z-facing surface of interposer 1106, and thence to pad 1114a on PCB 404. Likewise, a plurality of cathode capacitor vias 1206c connects each capacitor pad 1204c to the bottom cathode pad (not shown) on the negative-z-facing surface of interposer 1106, and thence to pad 1114c on PCB 404. Each of the anode capacitor vias 1206a is near to a corresponding cathode capacitor via 1206c in order to provide low anode-to-cathode inductance for current flow through the capacitor vias. Applying formula (16) with typical values [symbol] ₂=0.5 mm, a=0.125 mm, d=0.75 mm, c=0 yields L_{HOLE PAIR}=358 pH. For the case shown, the number of hole pairs is N=75, so, invoking equation (19), the inductance into the interposer board through the capacitor vias is 4.77 pH.

Similarly, still referring to FIG. 12, a plurality of anode stitch vias 1208a connects anode pad 1112a on the positive-z-facing surface of interposer 1106 to the bottom anode pad (not shown) on the negative-z-facing surface thereof, and thence to pad 1114a on PCB 404 (FIG. 11). Likewise, a plurality of cathode stitch vias 1208c connects cathode pad 1112a on the positive-z-facing surface of interposer 1106 to the bottom cathode pad (not shown) on the negative-z-facing surface thereof, and thence to pad 1114c (FIG. 11). Each of the anode stitch vias 1208a is near to a corresponding cathode stitch via 1208c in order to provide low anode-to-cathode inductance for current flow through the stitch vias. Applying formula (16) with values as in the previous paragraph except N=88 (the number of stitch via pairs shown in FIG. 12), the inductance into the interposer board through the stitch vias is 4.07 pH.

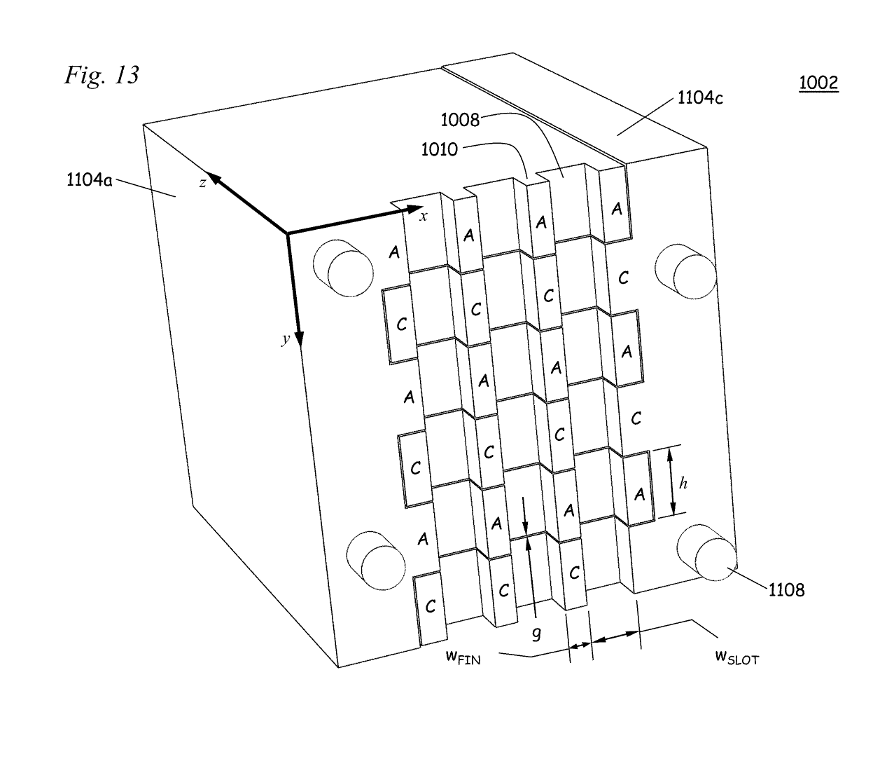

FIG. 13 illustrates a bottom-perspective view of the power connector 1002. As previously mentioned in connection with FIG. 10, the negative-z-facing surface of each electrode is partially cut away to accommodate capacitor 1110, thereby producing an integer number N_{S} of slots 1008 and fins 1010. For the case shown in FIG. 13, N_{S}=3. Referring to FIG. 13 as well as FIG. 11, anode portions A of the negative-z-facing surface of anode 1104a, each having dimensions w_{FIN}×h, are soldered to copper pad 1114a on PCB 404. Likewise cathode portions C of the negative-z-facing surface of cathode 1104c, each having dimensions w_{FIN}×h, are soldered to copper pad 1114c on PCB 404.

Referring to the particular case shown on FIG. 13, an inductance L₄ associated with current flowing through surfaces A and C into the PCB 404, is estimated by application of equation (11) with

dₓ=Distance normal to surface of PCB 404, from soldered surfaces to the power plane.

d_{z}=g

d_{y}=6h+20w_{FIN} (26)

where, referring to FIG. 13, g is the anode-to-cathode gap, and each fin has dimensions w_{FIN}×h. Thus

$${L}_{4} = {μ}_{0} \frac{{d}_{x} g}{6 h + 20 {w}_{FIN}} . \qquad ( 27 )$$

For the prototype,

dₓ=1.0 [mm]; g=0.1 [mm]; h=4.2 [mm]; w_{FIN}=1.4 [mm], (28)

whence, for the prototype

$${L}_{4} = ( 4 π \times {10}^{- 10} [ \frac{H}{mm} ] ) \frac{( 1.0 [ mm ] ) ( 0.1 [ mm ] )}{6 ( 4.2 [ mm ] ) + 20 ( 1.4 [ mm ] )} = 2.4 [ pH ] . \qquad ( 29 )$$

In the fourth embodiment, the purpose of the interposer assembly is, by virtue of capacitors 1110, to provide a capacitance C that counteracts the deleterious effects of an inductance L₁ associated with current flow between the power supply on PCBs 402 and the electronics on PCB 404 through board-to-board assembly 1000. Because a number N of capacitors 1110 are provided in parallel, each with a capacitance C₀, capacitance C is given by

C=NC₀ (30)

To understand the effect of capacitance C, consider FIG. 14, which is an electrical schematic diagram of board-to-board assembly 1000. The diagram illustrates not only capacitance C of capacitors 1110, but also the equivalent series resistance and equivalent series inductance thereof, denoted R₂ and L₂ respectively. The power supply has an equivalent resistance R₁. In series with R₁ is an inductance L₁ that represents the total inductance of the path from power supply to capacitors 1110. The electronic load 1402 consumes a time-variable current I₃. Because of this time-varying current demand from load 1402, circuit elements R₁, L₁, C, R₂, and L₂ cause a voltage V, which is delivered to load 1402, to differ from a constant, power-supply voltage level V₀.

Let

I₁≡Time-varying current through L₁ and R₁ (31)

I₂≡Time-varying current through L₂,R₂, and C (32)

I₃≡Time-varying current through load 1402 (33)

We seek to determine how the voltage V responds to a sinusoidal oscillation of the load current I₃. In particular, the purpose of the ensuing analysis is to demonstrate that capacitors 1110, which provide capacitance C, keep the voltage V closer to the ideal value V₀ than would occur if capacitors 1110 were absent.

By conservation of current

I₁=I₂+I₃. (34)

Consequently,

İ₁=İ₂+İ₃, (35)

where a dot represents a first derivative with respect to time t, for example

$${\dot{I}}_{1} ≡ \frac{{dI}_{1}}{dt} . \qquad ( 36 )$$

Moreover,

Ï₁=Ï₂+Ï₃, (37)

where a double-dot represents a second derivative with respect to time, for example

$${\ddot{I}}_{1} ≡ \frac{{d}^{2} {I}_{1}}{{dt}^{2}} . \qquad ( 38 )$$

By the definition of resistance, inductance and capacitance, inspection of FIG. 16 yields

$$\begin{matrix}{V}_{0} - V = {R}_{1} {I}_{1} + {L}_{1} {\dot{I}}_{1} and & ( 39 ) \\ V = {R}_{2} {I}_{2} + {L}_{2} {\dot{I}}_{2} + \frac{1}{C} \int {I}_{2} d t . & ( 40 )\end{matrix}$$

Differentiating equations (39) and (40) gives

$$\begin{matrix}- \dot{V} = {R}_{1} {\dot{I}}_{1} + {L}_{1} {\ddot{I}}_{1} & ( 41 ) \\ \dot{V} = {R}_{2} {\dot{I}}_{2} + {L}_{2} {\ddot{I}}_{2} + \frac{{I}_{2}}{C} & ( 42 )\end{matrix}$$

Comparing equations (41) and (42) yields

$${R}_{2} {\dot{I}}_{2} + {L}_{2} {\ddot{I}}_{2} + \frac{{I}_{2}}{C} = - ( {R}_{1} {\dot{I}}_{1} + {L}_{1} {\ddot{I}}_{1} ) . \qquad ( 43 )$$

Substituting equations (35) and (37) into equation (43) to eliminate I₁ in favor of I₂ yields

$${R}_{2} {\dot{I}}_{2} + {L}_{2} {\ddot{I}}_{2} + \frac{{I}_{2}}{C} = - [ {R}_{1} ( {\dot{I}}_{2} + {\dot{I}}_{3} ) + {L}_{1} ( {\ddot{I}}_{2} + {\ddot{I}}_{3} ) ] . \qquad ( 60 )$$

Rearranging equation (44) produces

$$( {L}_{1} + {L}_{2} ) {\ddot{I}}_{2} + ( {R}_{1} + {R}_{2} ) {\dot{I}}_{2} + \frac{{I}_{2}}{C} = - [ {R}_{1} {\dot{I}}_{3} + {L}_{1} {\ddot{I}}_{3} ] . \qquad ( 45 )$$

In accordance with normal practice, define an undamped natural frequency ω₀ of the system as

$${ω}_{0} ≡ \frac{1}{\sqrt{( {L}_{1} + {L}_{2} ) C}} , \qquad ( 46 )$$

and define a damping ratio ζ by

$$2 {ζω}_{0} ≡ \frac{{R}_{1} + {R}_{2}}{{L}_{1} + {L}_{2}} . \qquad ( 47 )$$

Then equation (45) may be written as

Ï₂+2ζω₀Ï₂+ω₀²I₂=−[αİ₃+βÏ₃] (48)

where, for brevity, α and β are defined as

$$α ≡ \frac{{R}_{1}}{{L}_{1} + {L}_{2}} ; β ≡ \frac{{L}_{1}}{{L}_{1} + {L}_{2}} . \qquad ( 49 )$$

Assume that the current demanded by load 1104 oscillates sinusoidally about a constant, nominal value I₃₀, the oscillation having an amplitude ΔI₃ and a circular frequency ω:

I₃(t)=I₃₀+ΔI₃ sin ωt. (50)

Assume the response

I₂(t)=A sin ωt+B cos ωt, (51)

where the constants A and B are to be determined. Substitution of equations (50) and (51) into equation (48) produces

$$- A {ω}^{2} sin ω t - β {w}^{2} cos ω t + 2 {ζω}_{0} ( A ω cos ω t - β w sin ω t ) + {ω}_{0}^{2} ( A sin ω t + B cos ω t ) = - [ α Δ {I}_{3} ωcos ω t - β Δ {I}_{3} {ω}^{2} sin ω t ] . \qquad ( 52 )$$

Separating the sin ωt and cos cot components in equation (52) yields:

sin ωt: −Aω²−2ζω₀ωB+Aω₀²=βΔI₃ω² (53)

cos ωt: −Bω²+2ζω₀ωA+Bω₀²=−αΔI₃ω (54)

Grouping terms in equations (53) and (54):

sin ωt: −(ω²−ω₀²)A−2ζω₀ωB=βΔI₃ω² (55)

cos ωt: 2ζω₀ωA−(ω²−ω₀²)B=−αΔI₃ω (56)

By Cramer's Rule

$$\begin{matrix}A = \frac{\vert \begin{matrix}β Δ {I}_{3} {ω}^{2} & - 2 {ζω}_{0} ω \\ - α Δ {I}_{3} ω & - ( {ω}^{2} - {ω}_{0}^{2} )\end{matrix} \vert}{\vert \begin{matrix}- ( {ω}^{2} - {ω}_{0}^{2} ) & - 2 {ζω}_{0} ω \\ 2 {ζω}_{0} ω & - ( {ω}^{2} - {ω}_{0}^{2} )\end{matrix} \vert} = \frac{- {ω}^{2} ( {ω}^{2} - {ω}_{0}^{2} ) β - 2 {ζω}_{0} {ω}^{2} α}{{( {ω}^{2} - {ω}_{0}^{2} )}^{2} + {( 2 {ζω}_{0} ω )}^{2}} Δ {I}_{3} & ( 57 ) \\ B = \frac{\vert \begin{matrix}- ( {ω}^{2} - {ω}_{0}^{2} ) & β Δ {I}_{3} {ω}^{2} \\ 2 {ζω}_{0} ω & - α Δ {I}_{3} ω\end{matrix} \vert}{\vert \begin{matrix}- ( {ω}^{2} - {ω}_{0}^{2} ) & - 2 {ζω}_{0} ω \\ 2 {ζω}_{0} ω & - ( {ω}^{2} - {ω}_{0}^{2} )\end{matrix} \vert} = \frac{ω ( {ω}^{2} - {ω}_{0}^{2} ) α - 2 {ζω}_{0} {ω}^{3} β}{{( {ω}^{2} - {ω}_{0}^{2} )}^{2} + {( 2 {ζω}_{0} ω )}^{2}} Δ {I}_{3} & ( 58 )\end{matrix}$$

Recall that the purpose of this analysis is to compute the magnitude of the oscillation in V, and to show that capacitance C makes it smaller than it would be if C were zero. For this purpose, substitute equation (51) and its derivatives into equation (42). The various derivatives of I₂ are

I₂=A sin ωt+B cos ωt (59)

İ₂=Aω cos ωt−Bω sin ωt (60)

Ï₂=−Δω² sin ωt−Bω² cos ωt. (61)

Substituting into equation (42) and grouping terms:

$$\dot{V} ( t ) = sin ω t [ - A {ω }^{2} {L}_{2} - B ω {R}_{2} + \frac{A}{C} ] + cos ω t [ - B {ω }^{2} {L}_{2} + A ω {R}_{2} + \frac{B}{C} ] . \qquad ( 62 )$$

Integrating to obtain V(t) produces

$$V ( t ) = cos ω t [ A ω {L}_{2} + {BR}_{2} - \frac{A}{ω C} ] + sin ω t [ - B ω {L}_{2} + {AR}_{2} + \frac{B}{ω C} ] + D , \qquad ( 63 )$$

where D is an integration constant, which is determined by considering the ideal condition when ΔI₃=0. According to equations (57) and (58), A=B=0 when ΔI₃=0, and moreover İ₁=0 according to equation (50), so in ideal conditions, according to equation (39),

V=V₀−I₁R₁=V₀−I₃₀R₁(ideal conditions,ΔI₃=0,A=B=0) (64)

Consequently, the integration constant D in equation (63) is

D=V₀−I₃₀R₁, (65)

and equation (63) may be rewritten as

$$Δ V ( t ) ≡ V ( t ) - ( {V}_{0} - {I}_{30} {R}_{1} ) = cos ω t [ A ω {L}_{2} + {BR}_{2} - \frac{A}{ω C} ] + sin ω t [ - B ω {L}_{2} + {AR}_{2} + \frac{B}{ω C} ] , \qquad ( 66 )$$

where equation (66) defines ΔV (t) as the difference between V Wand its ideal value.
Thus, summing the squares of the components in equation (66), the magnitude of the oscillation in ΔV (t) is

$$\vert Δ V ( t ) \vert = \sqrt{{[ A ω {L}_{2} + {BR}_{2} - \frac{A}{ω C} ]}^{2} + {[ - B ω {L}_{2} + {AR}_{2} + \frac{B}{ω C} ]}^{2}} . \qquad ( 67 )$$

The magnitude of this oscillation may be investigated numerically for various values of the parameters.

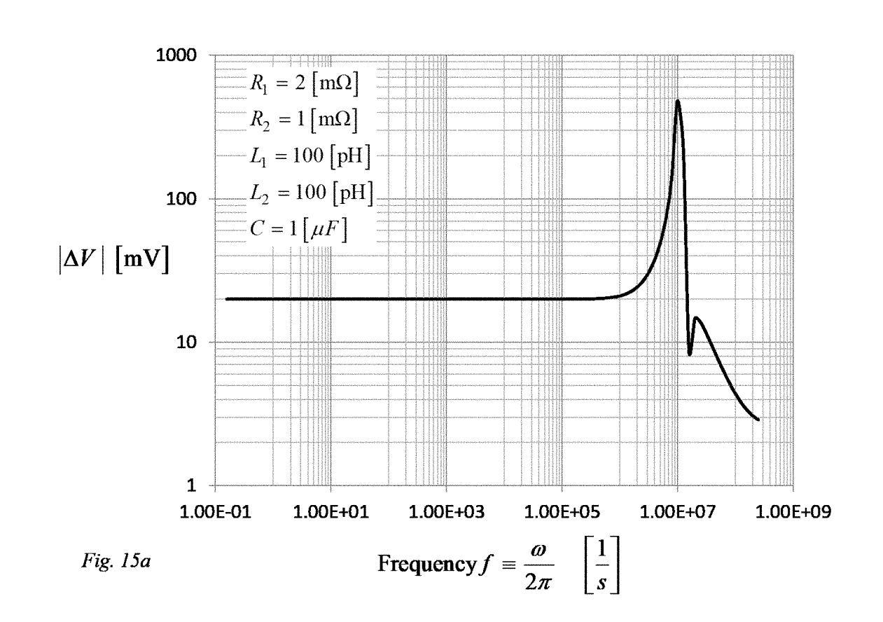

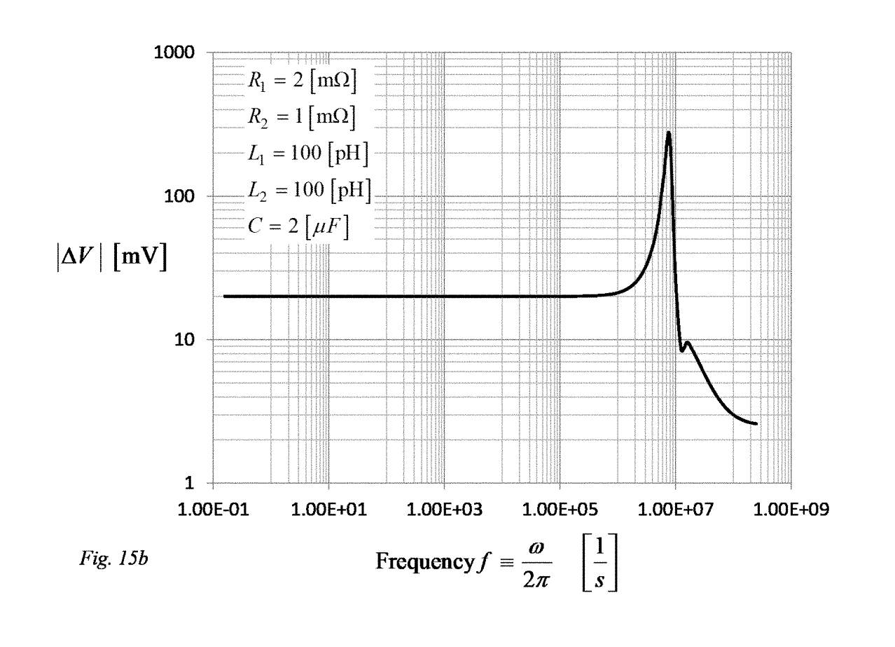

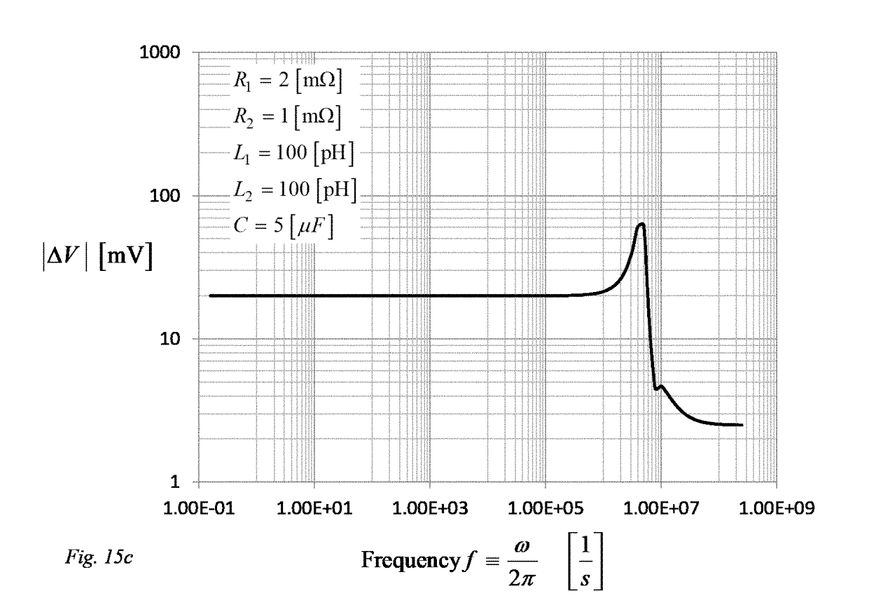

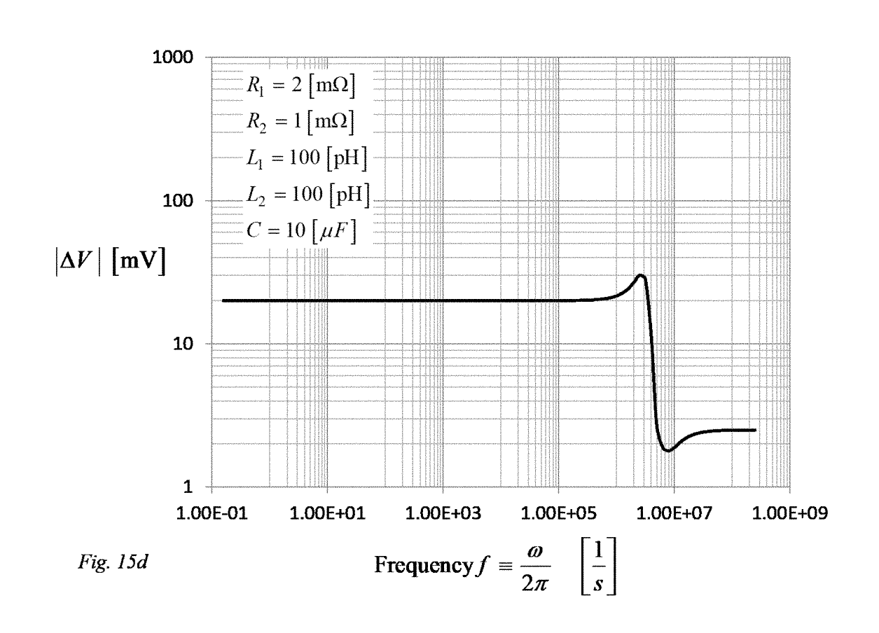

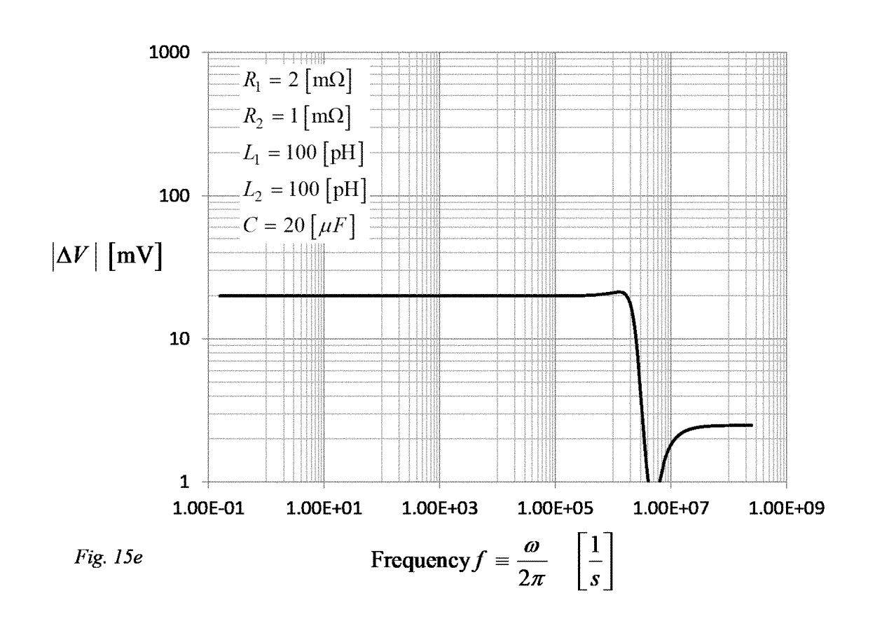

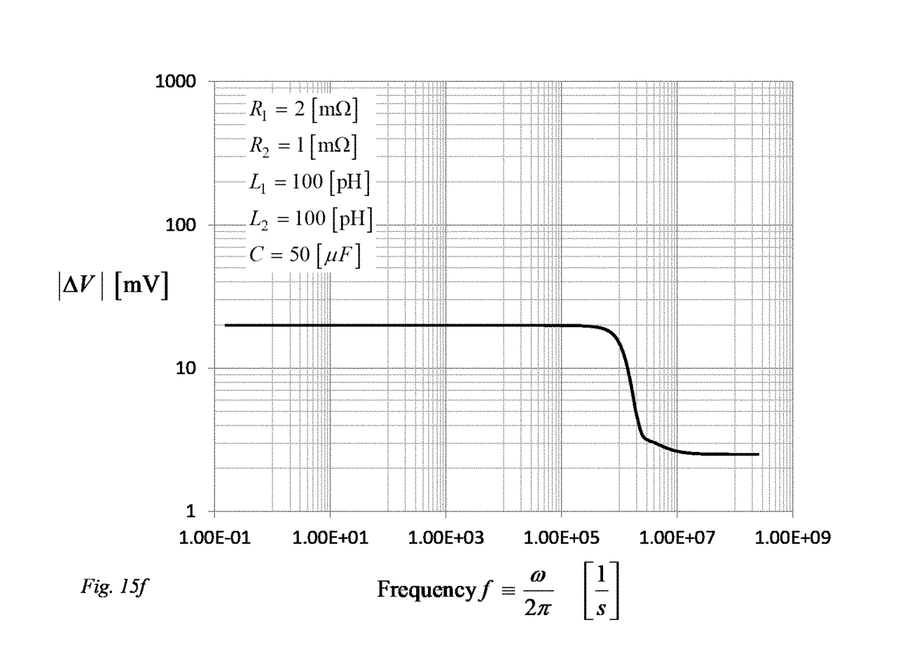

For example, FIGS. 15a through 15f illustrate plots of |ΔV| versus frequency

$$f ≡ \frac{ω}{2 π} \qquad ( 68 )$$

for various values of the capacitance C. Specifically:

On FIG. 15a: C=1 [μF]

On FIG. 15b: C=2 [μF]

On FIG. 15c: C=5 [μF]

On FIG. 15d: C=10 [μF]

On FIG. 15e: C=20 [μF]

On FIG. 15f: C=50 [μF] (69)

where the other parameters are held constant at the following values:

R₁=2 [mΩ]; R₂=1 [mΩ]; L₁=100 [pH]; L₂=100 [pH]; ΔI₃=10 [A]. (70)

The results clearly show the advantage of increasing capacitance C. That is, when C is only 1 μF (FIG. 15a), unacceptably large values of |ΔV|—up to 480 mV—occur in the frequency range around 10 MHz. When Cis increased to 5 μF (FIG. 15c), the peak value of |ΔV| is reduced to about 62 mV, and when C is increased to 20 μF, the peak value is barely above the low-frequency value of 20 mV, which is independent of C. For C=30 μF and above, further increasing C has no benefit, because, as shown in FIG. 15f for C=50 μF, the high-frequency values of |ΔV| are lower than the low-frequency value.

Whereas previous embodiments provided small |ΔV| by keeping R₁ and L₁ low, this fourth embodiment makes further improvements by providing capacitors 1110 (FIG. 12) that yield capacitance C within the connector. This capacitance C, together with a low connector-to-load inductance provided by vias 1206a, 1206c, 1208a, 1208c, further lowers the magnitude |ΔV| of load-voltage variation in response to the time variation in load current I₃ given by equation (50).

### CONCLUSION, RAMIFICATIONS, AND SCOPE

Thus the reader will see that, in accordance with one or more embodiments, high-current-capacity, low-resistance, low-inductance power connectors may be constructed for a variety of applications in which two electronic entities must be connected and a large, sometimes-fluctuating current passed between them with low loss. One or both entities may be disconnected from the connector, as may be required for servicing. Construction of the connector is straightforward, and manufacturing cost is low. While the above description contains much specificity, this should not be construed as limitations on the scope, but rather as an exemplification of several embodiments thereof. Many other variations are possible.

According to one or more embodiments, an electrical connector is provided for conducting current substantially parallel to a z direction of a Cartesian coordinate system comprising an x axis, a y axis, and a z axis, all mutually orthogonal, thereby defining an xy plane spanned by the x and y axes, an xz plane spanned by the x and z axes, and a yz plane spanned by the y and z axes. The electrical connector includes an anode formed into a first shape of uniform cross-section along the z direction, the first shape having a plurality of anode fingers that alternate with a plurality of anode gaps, and also includes a cathode formed into a second shape of uniform cross-section along the z direction, the second shape having a plurality of cathode fingers that alternate with a plurality of cathode gaps. The first and second shapes provide a conformity of one to the other, with the anode fingers being interdigitated with the cathode fingers and separated from the cathode fingers by an insulative anode-to-cathode gap. In one or more embodiments, the first and second shapes are substantially identical. The negative-z-facing surface of the anode may be substantially coplanar with the negative z-facing surface of the cathode, and the positive-z-facing surface of the anode may be substantially coplanar with the positive-z-facing surface of the cathode. In one or more embodiments, the electrical connector presents resistance of no more than 8.2 micro-ohm and inductance of no more than 185 picohenries. In one or more embodiments, the electrical connector presents a dynamic voltage drop of no more than 50 millivolt for a current varying at a maximum ramp rate of 100 ampere/microsecond. In one or more embodiments, the electrical connector also includes a solder pad and a locating pin for attaching one of the anode or the cathode to a circuit board. In one or more embodiments, the electrical connector also includes a threaded fastener for attaching one of the anode or the cathode to a circuit board. In one or more embodiments, the anode-to-cathode gap is filled with an insulator that has a magnetic permeability within 10 percent of the permeability of free space. In one or more embodiments, a dimension of the anode-to-cathode gap measured between adjacent fingers is less than 0.2 mm.

One or more embodiments provide an electrical connector for conducting current substantially parallel to a z direction of a Cartesian coordinate system having an x axis, a y axis, and a z axis, all mutually orthogonal, thereby defining an xy plane spanned by the x and y axes, an xz plane spanned by the x and z axes, and a yz plane spanned by the y and z axes. The electrical connector includes an anode, a cathode, and an interposer assembly. The anode is formed into a first shape of uniform cross-section along the z direction, the first shape having a plurality of anode fingers that alternate with a plurality of anode gaps. The cathode is formed into a second shape of uniform cross-section along the z direction, the second shape having a plurality of cathode fingers that alternate with a plurality of cathode gaps. The interposer assembly is attached on its positive-z-facing surface to the negative-z-facing surfaces of the anode and cathode, and includes an interposer printed-circuit board and a plurality of capacitors affixed to the interposer printed-circuit board to provide a capacitance. The first and second shapes provide a conformity of one to the other, with the anode fingers being interdigitated with the cathode fingers and separated from the cathode fingers by an insulative anode-to-cathode gap. The anode and the cathode are indented with slots at their negative-z-facing surfaces, and the capacitors of the interposer assembly fit into the slots of the anode and the cathode. In one or more embodiments, the first and second shapes are substantially identical. In one or more embodiments, the negative-z-facing surface of the anode is substantially coplanar with the negative z-facing surface of the cathode, and in which the positive-z-facing surface of the anode is substantially coplanar with the positive-z-facing surface of the cathode. In one or more embodiments, the electrical connector presents resistance of no more than 8.2 micro-ohm and inductance of no more than 185 picohenries. In one or more embodiments, the electrical connector presents a dynamic voltage drop of no more than 50 millivolt for a current varying at a maximum ramp rate of 100 ampere/microsecond. In one or more embodiments, the electrical connector also includes a solder pad and a locating pin for attaching one of the anode or the cathode to a circuit board. In one or more embodiments, the electrical connector also includes a threaded fastener for attaching one of the anode or the cathode to a circuit board. In one or more embodiments, the anode-to-cathode gap is filled by an insulator that has a magnetic permeability within 10 percent of the permeability of free space. In one or more embodiments, a dimension of the anode-to-cathode gap measured between adjacent fingers is less than 0.2 mm. In one or more embodiments, the slots extend continuously across the negative-z-facing surfaces of the anode and the cathode from the positive-y-facing surface to the negative-y-facing surface and define fins therebetween.

One or more aspects provide a method for reducing dynamic voltage drop in a board-to-board assembly. The method includes connecting a source printed-circuit board to a destination printed-circuit board via an interdigitated electrical connector, which includes an anode and a cathode. The anode is formed into a first shape of uniform cross-section along the z direction, the first shape having a plurality of anode fingers that alternate with a plurality of anode gaps. The cathode is formed into a second shape of uniform cross-section along the z direction, the second shape having a plurality of cathode fingers that alternate with a plurality of cathode gaps. The first and second shapes provide a conformity of one to the other, with the anode fingers being interdigitated with the cathode fingers and separated from the cathode fingers by an insulative anode-to-cathode gap. The method further includes providing a time-varying current from the source to the destination via the interdigitated electrical connector.

Accordingly, it will be understood that the descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### REFERENCE NUMERALS

The leading digit(s) of a reference numeral indicates the number of the figure whose discussion introduces it. For example, although reference numeral 302 appears on FIG. 1, it is introduced during the discussion of FIG. 3, so the leading digit is “3”.
100 Interdigitated power connector
102 Cartesian coordinate system
104a Anode assembly
104c Cathode assembly
106a Anode
106c Cathode
108 Locating pin
110a . . . 110c Fingers
202 Side gap, in y direction
204 End gap, in x direction
302a Hole in anode
302c Hole in cathode
400 Board-to-board assembly including connector 100
402 First PCB, to which connector 100 is affixed with fasteners
404 Second PCB, to which connector 100 is affixed by soldering
406a Copper pad on PCB 404 to which anode 106a is soldered
406c Copper pad on PCB 404 to which cathode 106c is soldered
410 Holes for locating pins 108
502a Threaded fastener engaging an anode hole 302a
502c Threaded fastener engaging a cathode hole 302c
506a Copper pad for anode connection
506c Copper pads for cathode connection
602 Coordinate system
604 First parallel plate
606 Second parallel plate
800 Connector according to a second embodiment
802a Anode
802c Cathode
804a Threaded portion of hole 302a
804c Threaded portion of hole 304c
806 Board-to-board assembly according to the second embodiment
808 PCB (printed-circuit board)
810a Fasteners for anode
810c Fasteners for cathode
812a Copper pad for anode
812c Copper pad for cathode
900 Connector according to a third embodiment
902a Anode
902c Cathode
906 Board-to-board assembly according to the third embodiment
908a Copper pad for anode
908c Copper pad for cathode
1000 Board-to-board assembly according to a fourth embodiment
1002 Connector according to the fourth embodiment
1004a Anode assembly
1004c Cathode assembly
1006 Interposer assembly
1104a Anode
1104c Cathode
1106 Interposer
1108 Locating pin
1110 Capacitor
1112a Copper pad on interposer for anode
1112c Copper pad on interposer for cathode
1114a Copper pad on board 404 for anode connection
1114c Copper pad on board 404 for cathode connection
1202a First terminal of capacitor 1110
1202c Second terminal of capacitor 1110
1204a Copper pad for first terminal 1202a
1204c Copper pad for second terminal 1202c
1206a Copper trace connecting pads 1204a
1206c Copper trace connecting pads 1204c
1208a Anode stitch vias
1208c Cathode stitch vias
1402 Electronic load

What is claimed is:

1. An electrical connector for conducting current substantially parallel to a z direction of a Cartesian coordinate system comprising an x axis, a y axis, and a z axis, all mutually orthogonal, thereby defining an xy plane spanned by the x and y axes, an xz plane spanned by the x and z axes, and a yz plane spanned by they and z axes, in which context the electrical connector comprises:
an anode formed into a first shape of uniform cross-section along the z direction, the first shape comprising a plurality of anode fingers that alternate with a plurality of anode gaps; and
a cathode formed into a second shape of uniform cross-section along the z direction, the second shape comprising a plurality of cathode fingers that alternate with a plurality of cathode gaps,
wherein the first and second shapes provide a conformity of one to the other, with the anode fingers being interdigitated with the cathode fingers and separated from the cathode fingers by an insulative anode-to-cathode gap.

2. The electrical connector as claimed in claim 1, wherein the first and second shapes are substantially identical.

3. The electrical connector as claimed in claim 1, wherein the negative-z-facing surface of the anode is substantially coplanar with the negative z-facing surface of the cathode, and in which the positive-z-facing surface of the anode is substantially coplanar with the positive-z-facing surface of the cathode.

4. The electrical connector as claimed in claim 1, wherein the electrical connector presents resistance of no more than 8.2 micro-ohm and inductance of no more than 185 picohenries.

5. The electrical connector as claimed in claim 1, wherein the electrical connector presents a dynamic voltage drop of no more than 50 millivolt for a current varying at a maximum ramp rate of 100 ampere/microsecond.

6. The electrical connector as claimed in claim 1, further comprising a solder pad and a locating pin for attaching one of the anode or the cathode to a circuit board.

7. The electrical connector as claimed in claim 1, further comprising a threaded fastener for attaching one of the anode or the cathode to a circuit board.

8. The electrical connector as claimed in claim 1, wherein the anode-to-cathode gap is filled with an insulator that has a magnetic permeability within 10 percent of the permeability of free space.

9. The electrical connector as claimed in claim 1, wherein a dimension of the anode-to-cathode gap measured between adjacent fingers is less than 0.2 mm.

10. An electrical connector for conducting current substantially parallel to a z direction of a Cartesian coordinate system comprising an x axis, a y axis, and a z axis, all mutually orthogonal, thereby defining an xy plane spanned by the x and y axes, an xz plane spanned by the x and z axes, and a yz plane spanned by they and z axes, in which context the electrical connector comprises:
an anode formed into a first shape of uniform cross-section along the z direction, the first shape comprising a plurality of anode fingers that alternate with a plurality of anode gaps;
a cathode formed into a second shape of uniform cross-section along the z direction, the second shape comprising a plurality of cathode fingers that alternate with a plurality of cathode gaps; and
an interposer assembly, which is attached on its positive-z-facing surface to the negative-z-facing surfaces of the anode and cathode, the interposer assembly comprising an interposer printed-circuit board and a plurality of capacitors affixed to the interposer printed-circuit board to provide a capacitance,
wherein the first and second shapes provide a conformity of one to the other, with the anode fingers being interdigitated with the cathode fingers and separated from the cathode fingers by an insulative anode-to-cathode gap,
wherein the anode and the cathode are indented with slots at their negative-z-facing surfaces, and the capacitors of the interposer assembly fit into the slots of the anode and the cathode.

11. The electrical connector as claimed in claim 10, wherein the first and second shapes are substantially identical.

12. The electrical connector as claimed in claim 10, wherein the negative-z-facing surface of the anode is substantially coplanar with the negative z-facing surface of the cathode, and in which the positive-z-facing surface of the anode is substantially coplanar with the positive-z-facing surface of the cathode.

13. The electrical connector as claimed in claim 10, wherein the electrical connector presents resistance of no more than 8.2 micro-ohm and inductance of no more than 185 picohenries.

14. The electrical connector as claimed in claim 10, wherein the electrical connector presents a dynamic voltage drop of no more than 50 millivolt for a current varying at a maximum rate of 100 ampere/microsecond.

15. The electrical connector as claimed in claim 10, further comprising a solder pad and a locating pin for attaching one of the anode or the cathode to a circuit board.

16. The electrical connector as claimed in claim 10, further comprising a threaded fastener for attaching one of the anode or the cathode to a circuit board.

17. The electrical connector as claimed in claim 10, wherein the anode-to-cathode gap is filled by an insulator that has a magnetic permeability within 10 percent of the permeability of free space.

18. The electrical connector as claimed in claim 10, wherein a dimension of the anode-to-cathode gap measured between adjacent fingers is less than 0.2 mm.

19. The electrical connector as claimed in claim 10, wherein the slots extend continuously across the negative-z-facing surfaces of the anode and the cathode from the positive-y-facing surface to the negative-y-facing surface and define fins therebetween.

20. A method for reducing dynamic voltage drop in a board-to-board assembly, the method comprising:
connecting a source printed-circuit board to a destination printed-circuit board via an interdigitated electrical connector, the interdigitated electrical connector comprising:
an anode formed into a first shape of uniform cross-section along the z direction, the first shape comprising a plurality of anode fingers that alternate with a plurality of anode gaps, and
a cathode formed into a second shape of uniform cross-section along the z direction, the second shape comprising a plurality of cathode fingers that alternate with a plurality of cathode gaps,
wherein the first and second shapes provide a conformity of one to the other, with the anode fingers being interdigitated with the cathode fingers and separated from the cathode fingers by an insulative anode-to-cathode gap; and
providing a time-varying current from the source to the destination via the interdigitated electrical connector.
